(19) United States
(12) Patent Application Publication
(10) Pub. No.: US 2009/0079911 A1
(43) Pub. Date: Mar. 26, 2009

(54) LIQUID CRYSTAL DISPLAY DEVICE

(75) Inventors: Hitoshi Nagato, Kunitachi-shi (JP); Rei Hasegawa, Yokohama-shi (JP); Haruhi Oooka, Kawasaki-shi (JP)

Correspondence Address: AMIN, TUROCY & CALVIN, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/211,845

(22) Filed: Sep. 17, 2008

(30) Foreign Application Priority Data
Sep. 25, 2007 (JP) 2007-248255

(51) Int. Cl. G02F 1/1335

(52) U.S. Cl. 349/95

(57) ABSTRACT

In a liquid crystal display device, a liquid crystal layer includes scattering liquid crystal is held between first and second substrates. The bottom surface of the second substrate is provided with a first prism array, which is extended along a first direction, and comprises a prism body arranged along a second direction. The bottom surface of the first prism array is provided with a second prism array, which is extended along the second direction, and comprises a prism body arranged along the first direction. The sum of the apex angles of the first and second prism arrays is set within a range from 180° to 240°. One of the apex angles is set larger than 90°.

### CROSS-REFERENCE TO RELATED APPLICATIONS

This application is based upon and claims the benefit of priority from prior Japanese Patent Application No. 2007-248255, filed Sep. 25, 2007, the entire contents of which are incorporated herein by reference.

### BACKGROUND OF THE INVENTION

1. Field of the Invention

The present invention relates to a liquid crystal display device realizing bright reflective display.

2. Description of the Related Art

As well known, a liquid crystal display (LCD) has the following advantages as compared with a CRT display. Specifically, the thickness of the LCD is made thin; therefore, this serves to perform space saving. Recently, the liquid crystal display is mainly used as display for home, office personal computer and notebook personal computer. In addition, most of mobile apparatuses such as advanced mobile phone, digital camera, digital video, car navigation use the liquid crystal display, so that a beautiful color image is displayed.

The liquid crystal display has the following disadvantages. Specifically, when the light incident from the surrounding area is strong, luminance and contrast ratio are reduced; for this reason, an unclear image is displayed. Light emitting or transmission display including the liquid crystal display emits light from itself. In a self-emission type display, when the light is incident from the surrounding area, there is a possibility that the image quality largely becomes worse. Therefore, the liquid crystal display must be designed to have specifications of high luminance (1000 cd/m²) and high contrast ratio (1000:1) in order to overcome light incident from the surrounding area.

The documents handled in a normal office work have luminance of about 250 cd/m² and contrast ratio of about 10:1 when being lightened by illumination. These documents reflect lights from the surrounding area, and the quantity of the reflected light changes depending on an incident light from the surrounding area. Thus, the documents are easier to be seen when the surrounding area are brighter. The light emitting/transmission display has extremely high luminance and high contrast ratio as compared with the document. For this reason, fatigue of the eyes occurs due to a long-time work; under certain circumstances, there is the case where display syndrome appears.

Considering the foregoing circumstances, it is desired to use a reflective display as a display for an OA personal computer or mobile apparatuses used at a bright place. A part of mobile phones partially uses the reflective display to see the image at a bright place. Various reflective displays have been proposed so far. Polymer dispersed liquid crystal (hereinafter, referred to simply a “PDLC”) is given as one example.

The PDLC has the following structure. Specifically, liquid crystal micro droplet dispersed in polymer are held in a thin film between a top glass substrate formed with an ITO electrode and a bottom glass substrate formed with an ITO electrode. Usually, in a state that liquid crystal micro droplet are dispersed in polymer, liquid crystal is not orientated. For this reason, liquid crystal molecular is orientated to various directions. When light is incident externally, the incident light is scattered in the PDLC. When a drive power source is connected between ITO electrodes to apply a voltage, liquid crystal molecular is orientated by applied field. Therefore, the incident lights from the outside are transmitted through the PDLC without being scattered in the PDLC. The transmitted lights passes through a thin air layer at the backside of the bottom glass substrate, and travel to a light absorber provided at the backside of the PDLC. In the PDLC having the foregoing structure, white appearance is observed in a state that the lights are scattered in the PDLC. In a state that the incident lights transmit through the PDLC, the color of the absorber at the backside of the PDLC is observed.

In the foregoing PDLC, an electric field is applied to liquid crystal small droplets dispersed in the polymer, and thereby, liquid crystal is orientated. The liquid crystal is used as an optical shutter, and thus, scattered/non-scattered state is switched. Thus, no polarizer is required in principle. In liquid crystal requiring the polarizer, the lights transmitted by the polarizer is limited. Liquid crystal is held between two substrates to support the liquid crystal; for this reason, there is a problem that half of the quantity of the incident light is absorbed. On the contrary, in the PDLC, the polarizer and orientation film are not used, and thereby, absorption of the quantity of light is largely reduced. As a result, a bright image is obtained. Thus, the PDLC is applied to a reflective display, which captures external lights to the display.

If a PDLC layer is used for the reflective display to obtain high reflectivity, that is, to display bright white appearance, there is a need of increasing a quantity of backscattering. However, when the reflective display is configured, there is a problem of causing a phenomenon that white is pale and the back image is transparent.

In order to solve the foregoing problem, the following proposal has been made. Specifically, the backside of the substrate is provided with a mirror to reflect the lights passing through the PDLC layer to the backside, and thus, the brightness of white appearance is improved. However, according to the foregoing method, there is a problem that an arbitrary color is not provided. In other words, the backside of the PDLC layer is used as a mirror surface; therefore, bright white is displayable. But, if the PDLC layer becomes transparent, the backside mirror is seen; for this reason, there is a problem that metallic silver and white are displayed.

The following structure disclosed in JP-A9-152598 (KOKAI) has been known as a reflective display increasing backscattering of the PDLC layer. According to the foregoing structure, a prism array is located at the backside of the PDLC layer. In the reflective display having the foregoing structure, a part of forward-scattered rays is totally reflected by the prism array, and then, backscattered, and thereafter, returned to the PDLC layer. Thus, the quantity of the backscattered rays is increased. The following structure is considered as a method of increasing reflectivity. Namely, another prism array is further overlapped, and then, arranged perpendicular to the prism to obtain higher reflectivity. However, the number of the prism arrays is increased, and thereby, black level reflectivity becomes high; as a result, there is a possibility that contrast ratio is reduced. In addition, the prism array is used, and thereby, there is a possibility that the viewing angle is reduced.

As described above, the reflective display using the PDLC has a problem that forward-scattering is reduced; as a result, bright white is not obtained. On the contrary, the following structure is employed; specifically, the backside of the PDLC layer is provided with a prism array. In this way, backscattering light is increased, and thereby, white reflectivity is increased to 50% or more such as newspaper. However, the prism array is used, and thereby, there is a problem of causing reduction of that contrast ratio and the viewing angle.

### BRIEF SUMMARY OF THE INVENTION

According to one aspect of the invention, there is provided a liquid crystal display device comprising:
a first substrate having a first surface provided with a first electrode;
a second substrate having a second surface provided with a second electrode facing the first electrode;
a liquid crystal layer including light scattering liquid crystal held between the first and second substrates;
a first prism array arranged at the side opposite to the second surface of the second substrate, the first prism array including a plurality of first prisms each having a first prism vertex portion extended along a first direction, the first prisms being arranged along a second direction crossing the first direction and the first prism vertex portion having a first apex angle;
a second prism array arranged under the first prism array, and, and further, the second prism array including a plurality of prisms each having a second prism vertex portion extended along the second direction, the second prisms being arranged along the first direction and the second prism vertex portion having a second apex angle, wherein the sum of the first and second apex angles are set to 180° more than and 240° or less, one of the first and second apex angle being larger than 90°; and
a light absorption layer arranged under the second prism array, and absorbing incident light rays.

### BRIEF DESCRIPTION OF THE SEVERAL VIEWS OF THE DRAWING

FIG. 1A and FIG. 1B are a perspective view and a cross-sectional view showing the structure of a liquid crystal display device according to one embodiment of the invention, respectively;

FIG. 2A and FIG. 2B are cross-sectional views showing the structure and ray tracing of a liquid crystal display device according to a comparison example 1;

FIG. 3A and FIG. 3B are cross-sectional views showing the structure and ray tracing of a liquid crystal display device according to a comparison example 2;

FIG. 4 is a graph showing white level and black level reflectivity in liquid crystal display devices according to comparison examples 1 to 3;

FIG. 5 is a graph showing measured values of white reflectivity, black reflectivity and contrast ratio in the liquid crystal display device shown in FIG. 1A and FIG. 1B;

FIG. 6 is a view showing ray tracing in a prism array to explain that a apex angle of a first prism array gives a big influence to contrast ratio in the liquid crystal display device shown in FIG. 1A and FIG. 1B;

FIG. 7 is a graph to explain the relationship between each apex angle of the first and second prism arrays and white reflectivity, black reflectivity and contrast ratio in the liquid crystal display device shown in FIG. 1A and FIG. 1B;

FIG. 8 is a graph to explain the relationship between the apex angle of the second prism array and the viewing angle in the liquid crystal display device shown in FIG. 1A and FIG. 1B; and

FIG. 9A and FIG. 9B are schematic views showing ray tracing in a combined prism array to explain that reflectivity changes depending on the arrangement of the prism array in the liquid crystal display device shown in FIG. 1A and FIG. 1B.

### DETAILED DESCRIPTION OF THE INVENTION

A liquid crystal display device according to one embodiment of the invention will be hereinafter described with reference to the accompanying drawings.

### First Embodiment

A reflective display using PDLC (Polymer dispersed liquid crystal) according to a first embodiment of the invention will be described in detail.

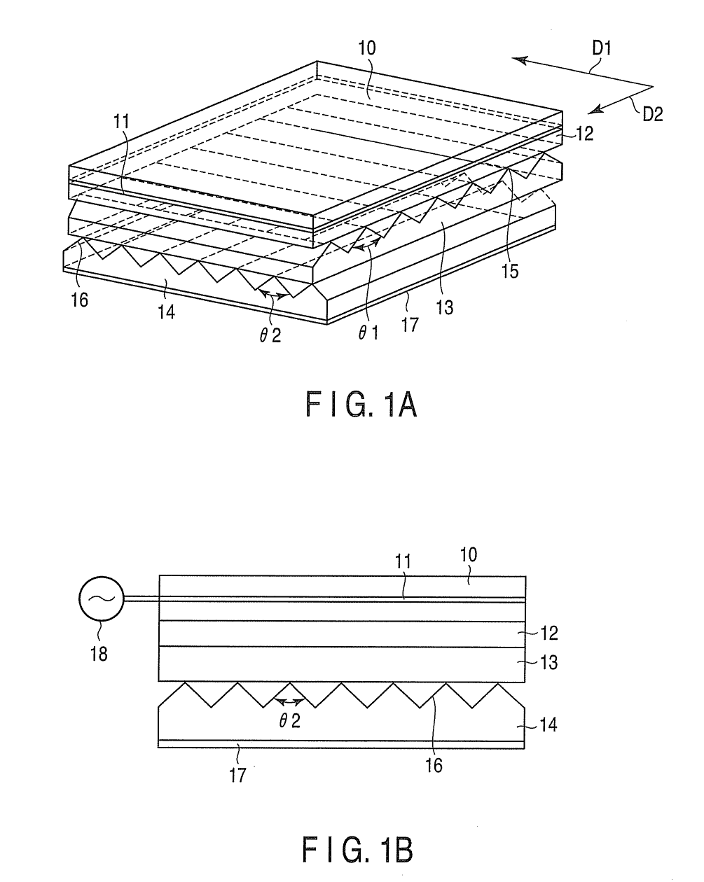

FIG. 1A and FIG. 1B show a basic structure of a reflective display combining PDLC and a prism array according to a first embodiment of the invention. FIG. 1A is a perspective view showing a PDLC display including a prism array at the backside. FIG. 1B is a cross-sectional view showing the structure of the display shown in FIG. 1A.

As shown in FIG. 1A and FIG. 1B, the PDLC display includes a top glass substrate 10 and a bottom glass substrate 12. The top glass substrate 10 is formed with a ITO electrode driving liquid crystal. The bottom glass substrate 12 is arranged facing the glass substrate 10 via a gap, and likewise, formed with an ITO electrode. The gap between the glass substrates 10 and 12 is provided with a PDLC layer 11 having liquid crystal micro droplet dispersed in polymer. In order to increase backscattering of the PDLC layer 11, the backside of the PDLC layer, that is, the backside of the bottom glass substrate 12 is provided with a first prism array 13 as seen from FIG. 1. A second prism array 14 having a apex portion 16 is arranged at the backside of the first prism array 13 to cross a vertex portion 15 of the first prism array 13. The backside of the second prism array 14 is provided with a light absorption layer 17. As depicted in FIG. 1b, each ITO electrode of the glass substrates 10 and 12 is connected to a liquid crystal drive source 18. When the liquid crystal drive source 18 turns off, externally incident lights are forward-scattered and backscattered so that white color display is made on the liquid crystal display as described later. When the liquid crystal drive source 18 is turned on, an electric field is applied to the PDLC layer 11 between ITO electrodes to give orientation to liquid crystal. In this way, externally incident lights are transmitted to the light absorption layer 17. Therefore, black or color of the light absorption layer 17 is displayed on the liquid crystal display.

The first and second prism arrays 13 and 14 are configured in such a manner that a plurality of prisms is integrally arrayed. In the first prism array 13, the apex portion 15 of the prism is extended to a first direction D1. A plurality of prisms is arrayed in a second direction D2 crossing the first direction D1, preferably, in the second direction D2 perpendicular to the first direction D1. Likewise, in the second prism array 14, the apex portion 16 of the prism is extended to the second direction D2, and a plurality of prisms is arrayed in the first direction D1.

According to the arrangement shown in FIG. 1A and FIG. 1B, the apex portion 15 of the first prism array 13 contacts with the backside of the bottom glass substrate 12. The apex portions 16 of the second prism array 14 contact with the bottom surface of the first prism array 13. The bottom surface of the second prism array 14 is provided with the light absorption layer 17. The foregoing two prism arrays 13 and 14 are provided at the backside of the bottom glass substrate 12, and thereby, it is possible to largely increase white reflectivity in the display.

The apex portion 15 of the first prism array 13 has a apex angle θ1, and the apex portion 16 of the second prism array 14 has a apex angle θ2. As described in the following, the sum (θ1+θ2) of the apex angle θ1 of the first prism array 13 and the apex angle θ2 of the second prism array 14 is set to a range from 180° or more and 240° or less. Either of the apex angle θ1 of the first prism array 13 or the apex angle θ2 of the second prism array 14 is set to 90° or more. Preferably, the apex angle θ1 of the first prism array 13 is set to 90° or more.

Hereinafter, referring to comparison examples 1, 2 and 3, the background of the following advantages will be described. According to the advantages, the first and second prism arrays 13 and 14 are provided at the backside of the bottom glass substrate, and the combination of these apex angles θ1 and θ2 is optimized to the foregoing range. In this way, high reflectivity is maintained, and the viewing angle is made large as possible as can, and further, high contrast ratio is obtained as possible as can.

### Comparison Example

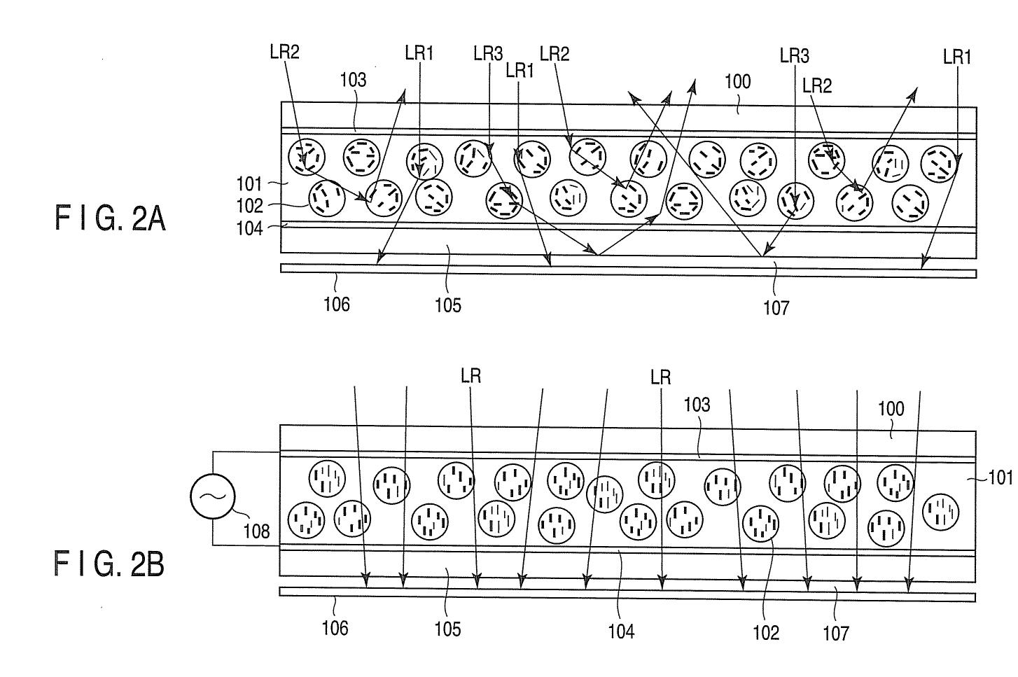

FIG. 2A and FIG. 2B each show a reflective display including no prism array according to a first comparison example. First, technical background of including prism arrays 13 and 14 will be described with reference to FIG. 2A and FIG. 2B. In FIG. 2A and FIG. 2B, a liquid crystal display device according to the comparison example 1 differs from that according to one embodiment of the present invention in that prism arrays 13 and 14 are not included. Other configuration is the same; therefore, an explanation is made as a part of the liquid crystal display device according to one embodiment of the invention.

Scattering in PDLC will be described with reference to FIG. 2A and FIG. 2B. FIG. 2A shows scattering of incident light in the PDLC in an off state that voltage is not applied. FIG. 2B shows a state that the incident light transmit through the PDLC and the display becomes transparent in an on state that voltage is applied.

As illustrated in FIG. 2A and FIG. 2B, light rays LR1 to LR3 are incident on a polymer dispersed liquid crystal layer (PDLC layer) 101 from externally various directions via an upper glass substrate 100 and an ITO electrode formed on the substrate 100. In the PDLC layer 101, liquid crystal micro droplet 102 are dispersed in polymer.

In a state that a drive source 108 is turned on so that a voltage is applied between ITO electrodes 103 and 104, the liquid crystal micro droplet 102, that is, liquid crystal molecular are oriented as seen from FIG. 2B. Light rays LR pass through the PDLC layer (polymer dispersed liquid crystal layer) 101, the ITO electrodes 104 and a bottom glass substrate 105 formed with the ITO electrode 104. Thereafter, the light rays reach a light absorber 106 located on the backside of the PDLC, and then, absorbed by the light absorber 106. Thus, the color of the light absorber on the backside is observed externally.

In a state that the drive source 108 is turned off, as shown in FIG. 2, the liquid crystal micro droplet 102 is not oriented. For this reason, the liquid crystal molecular is oriented to various directions. Externally incident light rays LR1 to LR3 are scattered, and then, in this scattered state, white could be observed. However, the color of a light absorption layer 106 is also seen in a transparent state. In the incident light rays LR1 to LR3, the light rays LR1 are scattered in the liquid crystal particles 102; however, pass through the PDLC layer 101. The foregoing scattering is called forward-scattering. On the contrary, as seen from light rays to which a reference numeral LR2 is given, there exist scattered light rays LR2, which are scattered by the liquid crystal micro droplets 102, and then, emitted to the incident side. The foregoing scattering is called backscattering. In addition, as seen from light rays to which a reference numeral LR2 is given, there exist scattered light rays LR3 (backscattering). The light rays LR3 pass through the PDLC layer 101 by forwardscattering. However, the light rays LR3 are totally reflected on the interface between the glass substrate 105 and an air layer at the backside of the glass substrate 105. Or, the light rays LR3 is reflected on the surface of the light absorption layer 106, and then, oriented to the incident side, and thereafter, emitted outside the PDLC. In the actual PDLC, these scatterings are complicatedly associated, and thus, scattering occurs. As a result, light rays are divided into forward-scattering light rays based on the light rays LR passing through the PDLC layer 101 and backscattering light rays based on light rays LR2 and LR3 retuned to the incident side of the PDLC layer 101. Other light rays are absorbed by the PDLC layer 101.

The PDLC layer 101 is used for the reflective display to display high reflectivity, that is, bright white appearance. In this case, backscattering must be increased. Light rays are reflected to the opposite side by forward-scattering; for this reason, the color of the light absorption layer 106 is transparently seen. In the PDLC layer 101, forward-scatting mainly occurs. However, the PDLC layer 101 is used for the reflective display, and thereby, the following phenomenon is observed. According to the phenomenon, white is pale and the under coating is transparent by backscattering.

In order to avoid the foregoing phenomenon, the following structure has been proposed. According to the structure, the backside of the substrate is made into a mirror surface, and thereby, light rays passing through the PDLC layer 101 are again reflected to the backside to improve white brightness. In the reflective display having the foregoing structure, the reflectivity of white color is given as 60% or more. However, the structure has a problem that it is impossible to give an arbitrary color. In other words, bright white display is possible in order to make the backside of the PDLC layer into a mirror surface. But, if the PDLC layer 101 becomes transparent, the mirror surface of the backside is seen. In this case, there is a problem metallic silver and white are displayed.

### Comparison Example 2

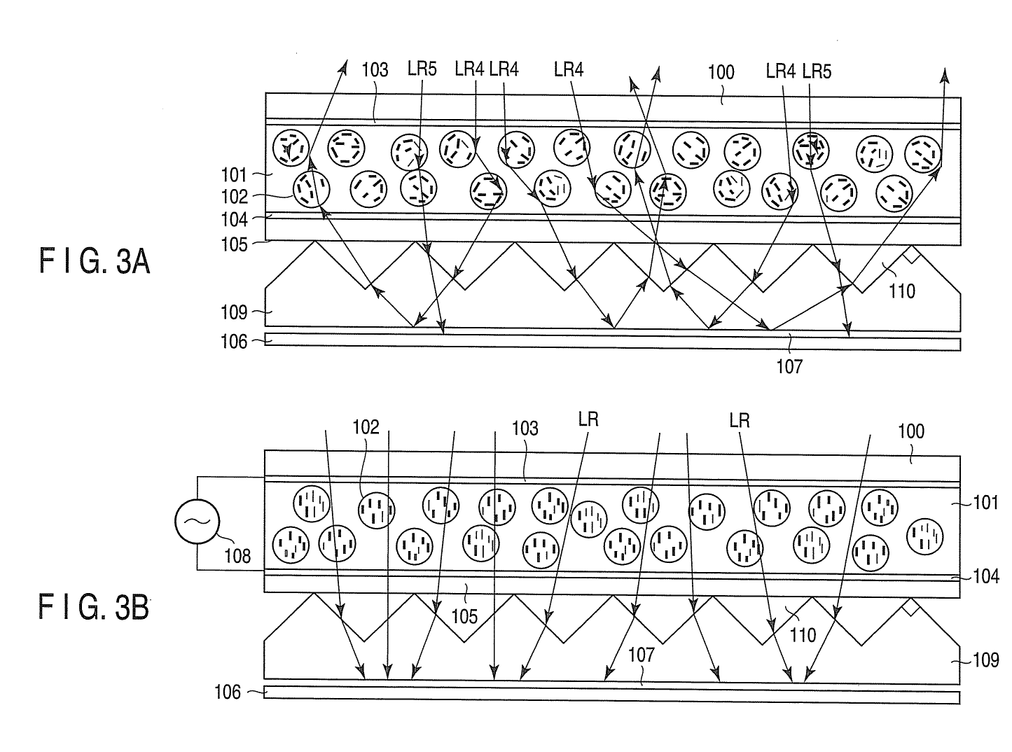

FIG. 3A and FIG. 3B each shows a reflective display according to a comparison example 2. In this case, the backside of the PDLC layer shown in FIG. 2 is provided with a single prism array. FIG. 3A shows scattering of incident light rays in the PDLC in an off state that voltage is not applied. FIG. 3B shows a state that incident light rays transmit through the PDLC layer, and the PDLC becomes transparent in an on state when voltage is applied. In the reflective display shown in FIG. 3A and FIG. 3B, a part of forward-scattered light is totally reflected by a prism array 109, and then, returned to the PDLC layer 101 as backscattering. In this way, backscattered light are increased. The prism array 109 is formed in such a manner that a right-angle prism array having a apex angle 90° is arrayed.

In a state that a drive source 108 is turned on so that voltage is applied between ITO electrodes 103 and 104, micro droplets 102, that is, liquid crystal molecular is oriented as seen from FIG. 3B. Light rays LR pass through PDLC layer (polymer dispersed liquid crystal layer) 101, ITO electrode 104, bottom glass substrate formed with the ITO electrode 104 and air layer 107. Thereafter, the light rays LR are refracted by the prism array 109 located on the backside of the PDLC layer, and then, reach the light absorber 106, and further, absorbed by the light absorber 106. When the reflective display is viewed from a direction close to the vertical direction in which an incident angle is small, the under colored layer 106 is seen through the prism array 109. Namely, the color of the backside light absorber is observed externally.

In a state that the drive source 108 is turned off, the liquid crystal micro droplets 102 are not oriented as seen from FIG. 3A. For this reason, liquid crystal molecular is oriented to various directions, and externally incident light rays LR4 and LR5 are scattered; as a result, white is observed. In FIG. 3A, light rays tracing shown by LR4 and LR5 show the travels of forward-scattered light rays.

As shown in FIG. 3A, forward-scattered light rays LR4 and LR5 pass through the PDLC layer 101, and thereafter, transmit through the ITO electrode and the glass substrate 105, and then, are oriented to the backside of the substrate 105. The passed forward-scattering light rays LR4 and LR5 come into individual prism arrays forming the prism array 109 via the air layer 110.

The light ray LR5, that is, forward-scattering light having a small incident angle on the prism array passes through the prism array 109 as shown in FIG. 3A. Thereafter, the light ray LR5 is oriented to the light absorption layer 106 via the air layer 107 at the backside of the prism array 109. Thus, the light ray LR5 is absorbed by the light absorption layer 106. On the contrary, the forward-scattering light ray LR4 in FIG. 3A, that is, light ray having a large incident angle to the prism array 109 is totally reflected by the boundary surface between the prism array 109 and the air layer 107 on the backside of the prism array 109. The totally reflected light ray is again returned to the PDLC layer 101, and then, again scattered. In other words, a part of the light ray passing through the PDLC layer 101 by forward-scattering is again returned to the PDLC layer 101. As a result, this distributes for backscattering. As described above, the backside of the PDLC layer 101 is provided with the prism array 109, and thereby, backscattering light rays are increased to increase white reflectivity.

### Comparison Example 3

Further, the structure of obtaining a larger reflectivity is considered. According to the structure, the prism array 109 shown in FIG. 3A and FIG. 3B is arranged perpendicular to another prism array 109 so that these prism arrays are overlapped. The added prism array 109 is formed in such a manner that a right-angle prism array having a apex angle 90° is arrayed.

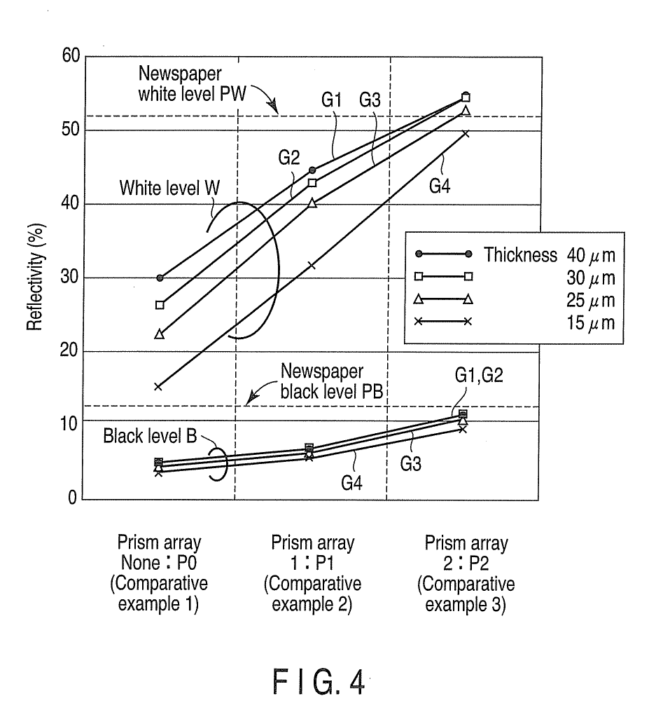

FIG. 4 is a graph showing the relationship between the number of prism arrays 109, white reflectivity and reflectivity of colored layer (black) when the thickness of the PDLC layer 101 is changed. In FIG. 4, a symbol W denotes reflectivity of white level curves G1, G2, G3 and G4, and a symbol B denotes reflectivity of black level curves G1, G2, G3 and G4. The curve G1 shows a change of reflectivity of white level W and black level B when the thickness of the PDLC layer is 40 μm. The curve G2 shows a change of reflectivity of white level W and black level B when the thickness of the PDLC layer is 30 μm. The curve G3 shows a change of reflectivity of white level W and black level B when the thickness of the PDLC layer is 25 μm. The curve G4 shows a change of reflectivity of white level W and black level B when the thickness of the PDLC layer is 15 μm. In FIG. 4, the horizontal axis of the graph shows measurement of the following liquid crystal display devices. One is a liquid crystal display device provided no prism array 109 (prism array: none: P0). Another is a liquid crystal display device provided one prism array 109 (prism array: 1: P1). Another is a liquid crystal display device provided two prism array 109 (prism array: 2: P2). In FIG. 4, white level PW of newspaper and black level PB of newspaper are shown using a broken line for comparison.

From the curves G1 to G4 shown in FIG. 4, it can be seen that the thicker the PDLC layer 101 is, the higher the reflectivity of white becomes. A comparison is made between the case of using the prism array 109 and the case of using no prism array 109. In this case, the prism array 109 is used, and thereby, it can be seen that the reflectivity considerably becomes high. In addition, two prism arrays 109 are used, and thereby, it is possible to exceed the reflectivity of about 50% equivalent to the white level PW of newspaper.

However, the PDLC layer 101 is made thicker (G4>G1) and the number of the prism arrays is increased, and thereby, the reflectivity of the black level simultaneously becomes high. Contrast ratio is given as one of performance evaluation of the display device. The contrast ratio is a ratio of the reflectivity of the white level W to the reflectivity of the black level B. A change of the reflectivity of the black level B gives a large influence to the contrast ratio. Specifically, when the PDLC layer 101 is thicker and the number of the prism arrays 109 is increased, the reflectivity of the black level B increased case by case. For this reason, there is the case where the contrast ratio is reduced. In addition, there is another problem. Namely, the prism array 109 is used, and thereby, the viewing angle decreases. As illustrated in FIG. 2A, the prism array 109 is used, and thereby, the reflectivity of white is increased using total reflection. As shown in FIG. 2B, when viewing the display from a direction close to the vertical direction in a state that voltage is applied, the under colored layer is seen. However, total reflection occurs when viewing the display from an oblique direction. An angle causing total reflection is equivalent to a viewing angle. When two prism arrays are used, there is a problem that the viewing angle decreases by ±25° in right and left and up and down.

From the foregoing background, the liquid crystal display device according this embodiment of the invention shown in FIG. 1A and FIG. 1B has the following advantage. Namely, the combination of the apex angle θ1 of the prism apex portion 15 of the first prism array 13 and the apex angle θ2 of the prism array apex portion 16 of the second prism array 14 is optimized. Specifically, the sum (θ1+θ2) of the apex angle (θ1) of the first prism array and the apex angle (θ2) of the second prism array is set to 180° or more and less than 240°. Either of the apex angle (θ1) of the first prism array and the apex angle (θ2) of the second prism array is set to 90° or more. Based on the foregoing optimization, high contrast ratio and wide viewing angle are realizable while maintaining the reflectivity of the white level to some degree as described in the following.

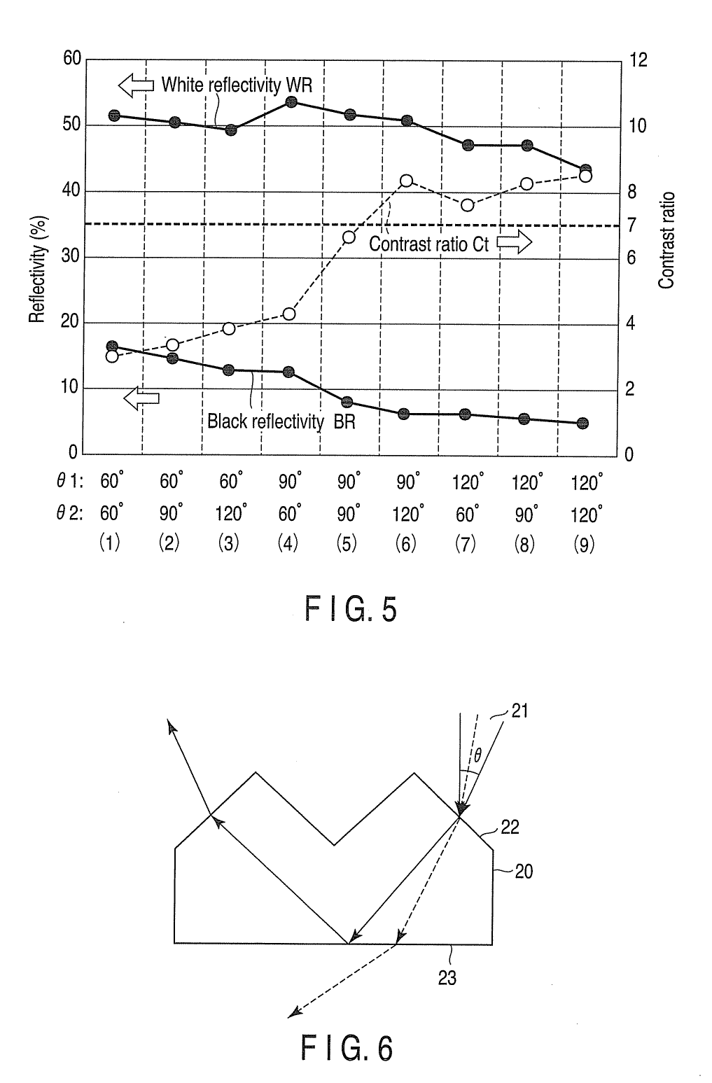

FIG. 5 is a graph showing lines WR, BR and Ct plotting reflectivity of white level, reflectivity of black level and contrast ratio when the combination of the apex angle (θ1) of the apex portion 15 of the first prism array 13 and the apex angle (θ2) of the apex portion 16 of the second prism array 14 is changed.

The apex angle (θ1) of the first prism array 13 and the apex angle (θ2) of the second prism array 14 each formed having three angles, that is, 60°, 90° and 120°. The experiment was carried out with respect to nine combinations in total. As is evident from lines WR, BR and Ct, white reflectivity, black reflectivity and contrast ratio values were largely changed according to the combination of the apex angles θ1 and θ2. High white reflectivity, low black reflectivity and high contrast ratio verifies good characteristic. Numerals (1) to (9) correspond to the combinations of the apex angles θ1 and θ2.

An influence of white reflectivity WR, black reflectivity BR and contrast ratio Ct given by a change of the apex angle θ1 of the first prism array 13 and by a change of the apex angle θ2 of the second prism array 14 is considered. As seen from FIG. 5, the influence by the apex angle θ1 of the first prism array 13 is big. Two prism arrays 13 and 14 are used, and thereby, the white reflectivity WR is kept to around 50%. However, the black reflectivity receives an influence by the apex angle θ1 of the first prism array 13. Namely, when the apex angle θ1 is small, the black reflectivity BR becomes high. The contras Ct is obtained by dividing white reflectivity WR by the black reflectivity BR. Thus, a change of the black reflectivity BR close to 0 largely gives an influence to the contrast ratio CT as compared with a change of the white reflectivity WR. As is evident from FIG. 5, the black reflectivity BR receives a big influence by the apex angle θ1 of the first prism array 13. For this reason, when the contrast ratio Ct is calculated, the contrast ratio Ct receives a big influence by the apex angle θ1 of the first prism array 13. In other words, there is a tendency for the contrast ratio to become high when the apex angle θ1 of the first prism array 13 is larger.

An ideal of the reflective display has high contrast ratio Ct and high white reflectivity WR, that is, a bright display is required. The contrast ratio of newspaper, that is, 7:1 is given as a reference value of the contrast ratio Ct. As seen from FIG. 5, when the apex angle θ1 of the first prism array 13 is 60°, the contrast ratio Ct is very low regardless of the apex angle θ2 of the second prism array 14. On the contrary, when the apex angle θ1 of the first prism array 13 is 120°, the contrast ratio Ct is more than 7 regardless of the apex angle θ2 of the second prism array 14. When the apex angle θ1 of the first prism array 13 is 90°, the contrast ratio Ct receives a big influence by the second prism array 14. When the contrast ratio Ct is more than 7, the apex angle θ2 of the second prism array 14 is required more than 120°.

As seen from FIG. 5, the conditions of realizing high contrast ratio and reflectivity as the reflective display are as follows. First, the apex angle of the first prism array 13 is more than 90°. Secondary, the sum of the apex angle θ1 of the first prism array 13 and the apex angle θ2 of the second prism array 14 is more than 180°. When both of the apex angle θ1 of the first prism array 13 and the apex angle θ2 of the second prism array 14 are 90°, the contrast ratio Ct cannot obtain a value more than 7. One of the apex angle θ1 of the first prism array 13 and the apex angle θ2 of the second prism array 14 must be required more than 90°.

As seen From FIG. 5, the white reflectivity is around 50%, and has no large change so long as the sum (θ1+θ2) of the first prism array 13 and the second prism array 14 does not reach about 200°. The white reflectivity is gradually reduced in the order of the apex angle θ1 of the first prism array 13, that is, 90°, 60° and 120°. On the contrary, the white reflectivity is gradually reduced in the order of the apex angle θ2 of the second prism array 14, that is, 60°, 90° and 120° with respect to the apex angle θ1 of the first prism array 13. The black reflectivity BR is reduced in the order of the apex angle θ1 of the first prism array 13, that is, 60°, 90° and 120°. The black reflectivity BR is gradually reduced in the order of the apex angle θ2 of the second prism array 14, that is, 60°, 90° and 120° with respect to the apex angle θ1 of the first prism array 13. Thus, it can be seen that the black reflectivity BR mainly receives an influence of the apex angle θ1 of the first prism array 13. The contrast ratio Ct is obtained by dividing the white reflectivity WR by the black reflectivity BR; therefore, it is easy to receive an influence of the black reflectivity BR. In other words, the contrast ratio Ct largely receives an influence of the apex angle θ1 of the first prism array 13. Therefore, it is preferable that the apex angle θ1 of the first prism array 13 is larger than 90°.

Referring now to FIG. 6, the reason why the first prism array 13 gives a big influence to the black reflectivity BR will be explained. An incident light 21 shown by a broken line to a prism array 20 refracts on a prism array slant surface 22, and then, travels in the prism array 20. The light traveled to a prism array bottom surface 23 again refracts, and then, travels outside as shown by a broken line. When the incident angle θ to the prism array 20 is large to some degree, the incident light totally reflects on the prism array bottom surface 23 as shown by a solid line. Then, the incident light again travels outside to prism array 20 along the path shown in FIG. 6. The incident angle generating the total reflection becomes large when the apex angle of the prism array is large. For example, the incident angle is 33° when the apex angle θ is 60°. The incident angle is 40° when the apex angle θ is 90°. The incident angle is 58° when the apex angle θ is 120. In order to sufficiently express strong black by reducing the black reflectivity BR, the light ray incident on prism array 20 has a need to reach a black colored layer on the backside. Specifically, if the prism array 20 is equivalent to the first prism array 13, when totally reflected light rays on the first prism array 13 are increased, light rays passing through the lower side (second prism array 14) is reduced. As described above, the total reflection occurs at the incident angle of 33°, 40° and 58° when the apex angle θ is 60√, 90° and 120°. Thus, when the apex angle is 120°, light rays pass through the lower side in a range of about twice case where the apex angle θ is 60°. In other words, when light rays pass through the first prism array 13, the big difference is given in light rays passing trough the lower side depending on the apex angle θ1 of the first prism.

When the sum of the apex angles of the first and second prism arrays 13 and 14 is 240°, the black reflectivity BR considerably becomes low. Thus, the contrast ratio Ct can obtain a sufficient large value. However, the white reflectivity WR is reduced to about 45%, and therefore, becomes darker than newspaper. If the sum of the apex angle is set larger, black becomes strong; for this reason, the improvement of the contrast ratio Ct is obtained; however, the white reflectivity WR is further reduced. Therefore, the apex angle more than above should be avoided to realize a bright reflective display. The upper limit of the sum (θ1+θ2) of the apex angles θ1 and θ2 of the first and second prism arrays 13 and 14 is 240°.

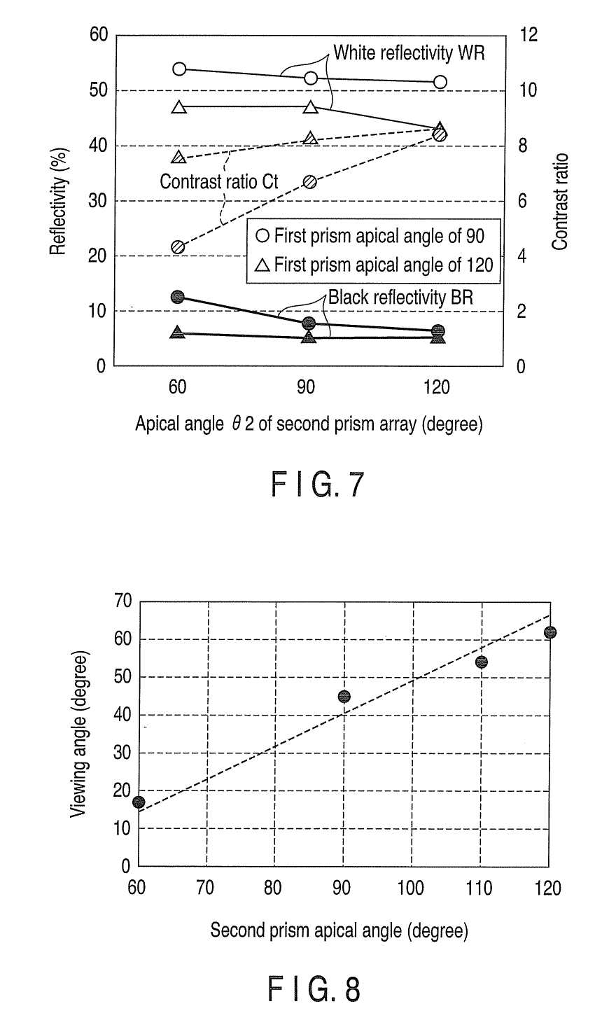

The viewing angle will be described below. FIG. 7 is a graph rewriting measurement data of FIG. 5, and shows dependency of white reflectivity WR, black reflectivity BR and contrast ratio Ct with respect to the apex angle θ2 of the second prism array 14. In FIG. 7, a mark ◯ shows the case where the apex angle θ1 is 90°, and a mark Δ shows the case where the apex angle θ1 is 120°. As seen from FIG. 7, when the apex angles θ1 of the first prism array 13 is 90° and the apex angle θ2 of the second prism array is 120°, the white reflectivity WR, the black reflectivity BR and the contrast ratio Ct are optimized. FIG. 8 shows measurement data of a viewing angle measured when the apex angle θ2 of the second prism array 14 is variously changed under the condition that the apex angle θ1 of the first prism arrays 13 is 90°. The viewing angle when the apex angle θ1 of the first prism arrays 13 is 90° and the apex angle θ2 of the second prism array 14 is 60° is less than 20°. Thus, when the display is view from the slightly oblique direction, black is actually seen; nevertheless, it is seen as silver due to total reflection. When the apex angle θ1 of the first prism arrays 13 is 90° and the apex angle θ2 of the second prism array 14 is 90°, the viewing angle becomes slightly wide, and thus, has about 40°. When the apex angle θ1 of the first prism arrays 13 is 90° and the apex angle θ2 of the second prism array 14 is 120°, the viewing angle becomes wider, and thus, has about 60°. From the foregoing experiment, the best combination was obtained. Namely, when the apex angle θ1 of the first prism arrays 13 is 90° and the apex angle θ2 of the second prism array 14 is 120°, the white reflectivity WR has a satisfied value, the contrast ratio Ct is the highest value, and the viewing angle is sufficiently wide, that is, 60°. Therefore, preferably, the first apex angle is set to a range from 90° to 120°, and the second apex angle is set to a range from 90° to 120°. Or, preferably, the first apex angle is set to 90°, and the second apex angle is set to 120° and the first apex angle is set to 120°, and the second apex angle is set to 90°.

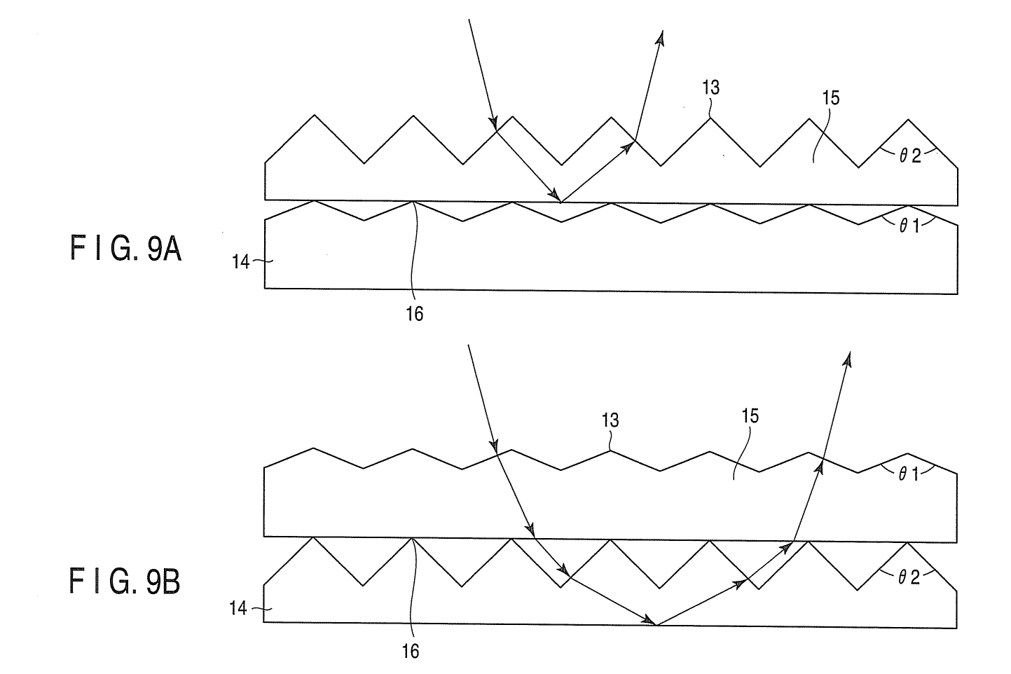

Referring now to FIG. 9A and FIG. 9B, the reason why the reflectivity is different in the following cases in the reverse order will be described. One is the case where the apex angle θ1 of the first prism array 13 is 60° and the apex angle θ2 of the second prism array 14 is 120°. Another is the case where the apex angle θ1 of the first prism array 13 is 120° and the apex angle θ2 of the second prism array 14 is 60°. Inherently, even if the order of the apex angle of the prism array is changed, there occurs no difference in reflectivity considering the light ray tracing. The factor that difference occurs in the actually measured reflectivity is not analyzed. However, the following two factors are qualitatively considered. One is the factor of loss generated in prism arrays 13 and 14. Another is the factor resulting from the reason why much total reflection occurs in either of prism arrays 13 or 14. As illustrated in FIG. 9A, the apex angle θ1 of the first prism array 13 is small, and the apex angle θ2 of the second prism array 14 is large. In this case, as seen from FIG. 9A, light rays incident from a certain direction is totally reflected on the bottom surface of the first prism array 13. Then, the reflected light rays are again emitted from the first prism array 13. On the contrary, as illustrated in FIG. 9B, the apex angle θ1 of the first prism array 13 is large, and the apex angle θ2 of the second prism array 14 is small. In this case, light rays incident at the same angle the angle shown in FIG. 9A transmit through the first prism array 13, and then, is incident on the second prism array 14, and thereafter, totally reflect on the bottom surface of the second prism array 14. Thus, the foregoing light rays are again emitted from the first prism array along the path shown in FIG. 9B. As a result, the light rays totally reflect, and then, returns; however, the path is largely different as seen FIG. 9. As shown in FIG. 9B, if the path becomes long, loss increases in the prism array; in addition, loss resulting from surface reflection generated at the boundary surface of mediums increases. Thus, the case where the apex angle θ1 of the first prism array 13 is 60° and the apex angle θ2 of the second prism array 14 is 120° is one factor of increasing the reflectivity as compared with the case where the apex angle θ1 of the first prism array 13 is 120° and the apex angle θ2 of the second prism array 14 is 60°.

In the liquid crystal display device, the backside of the PDLC layer is provided with two prism arrays. In this way, white reflectivity is increased in the same as newspaper. In addition, the foregoing two prisms array are optimally set to realize high contrast ratio and wide viewing angle while maintain white reflectivity to some degree. The liquid crystal display device expresses bright white appearance, and it is possible to realize a reflective liquid crystal display device, which is easy to be seen.

As described above, it is possible to provide a liquid crystal display device, which increases white reflectivity using the prism arrays, and prevents reduction of contrast ratio and viewing angle as possible as can.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A liquid crystal display device comprising:
a first substrate having a first surface provided with a first electrode;
a second substrate having a second surface provided with a second electrode facing the first electrode;
a liquid crystal layer including light scattering liquid crystal held between the first and second substrates;
a first prism array arranged at the side opposite to the second surface of the second substrate, the first prism array including a plurality of first prisms each having a first prism vertex portion extended along a first direction, the first prisms being arranged along a second direction crossing the first direction and the first prism vertex portion having a first apex angle;
a second prism array arranged under the first prism array, and, and further, the second prism array including a plurality of prisms each having a second prism vertex portion extended along the second direction, the second prisms being arranged along the first direction and the second prism vertex portion having a second apex angle, wherein the sum of the first and second apex angles are set to 180° more than and 240° or less, one of the first and second apex angle being larger than 90°; and
a light absorption layer arranged under the second prism array, and absorbing incident light rays.

2. The device according to claim 1, wherein the first apex angle is larger than 90°.

3. The device according to claim 1, wherein the liquid crystal layer comprises polymer dispersed liquid crystal.

4. The device according to claim 1, wherein the first apex angle is set within a range from 90° to 120°, and the second apex angle is set within a range from 60° to 120°.

5. The device according to claim 1, wherein the first apex angle is set within a range from 90° to 120°, and the second apex angle is set within a range from 90° to 120°.

6. The device according to claim 1, wherein the first apex angle is set to 90°, and the second apex angle is set to 120°.

7. The device according to claim 1, wherein the first apex angle is set to 120°, and the second apex angle is set to 120°.
